(19) United States
(12) Patent Application Publication
(10) Pub. No.: US 2009/0272208 A1
(43) Pub. Date: Nov. 5, 2009

(54) WINDOW WIPER SYSTEM WITH A WINDOW WIPER DRIVE, IN PARTICULAR FOR A REAR WINDOW WIPER OF A MOTOR VEHICLE WITH A GEAR ARRANGEMENT WHICH CAN BE EXCHANGED IN A MODULAR MANNER

(75) Inventors: Roland Bohn, Buehl (DE); Paul Geubel, Baden-Baden (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,228

(22) PCT Filed: Jul. 12, 2007
(86) PCT No.: PCT/EP2007/057139

§ 371 Date: Dec. 17, 2008

(30) Foreign Application Priority Data
Sep. 8, 2006 (DE) 10 2006 042 322.4

(51) Int. Cl. F16H 57/02; F16H 21/18

(52) U.S. Cl. 74/47; 74/606 R

(57) ABSTRACT

The invention relates to a window wiper system with a window wiper drive (1), in particular for rear window wipers of a motor vehicle, with a gear housing (10), which can be closed by means of a housing cover (14), for accommodating a gear arrangement (11), wherein the gear housing (10) and the housing cover (14) each have a run-on surface (15a, 15b) for the axial guidance of the gear arrangement (11). When the housing cover (14) is closed, an intermediate space (16) is formed between the mutually opposite run-on surfaces (15a, 15b), said intermediate space corresponding to the geometrical dimensions of an installation region of the gear arrangement (11) to be inserted.

### BACKGROUND OF THE INVENTION

The present invention relates to a window wiper system with a window wiper drive, in particular for a rear window wiper of a motor vehicle.

Window wiper systems of the abovementioned type are already known. Laid-open specification DE 100 14 735 A1 discloses a window wiper drive of the type in question which has a gear housing into which a gear is installed, and which can be closed by means of a housing cover. The gear is designed as a conversion mechanism which is driven by means of a drive motor, a worm and a worm wheel. A connecting rod which is connected in a hinged manner to a web is fastened to the worm wheel. The web creates a uniformly spaced-apart connection between the joint of the connecting rod and the wiper shaft. On one side of the wiper shaft, a window wiper is arranged in a rotationally fixed manner outside the gear housing. On the opposite side of the wiper shaft, a pinion which meshes with a toothed segment on the connecting rod is fastened within the gear housing. The wiper shaft therefore executes an oscillating movement during a homogeneous circular movement of the worm wheel.

A guide web is mounted rotatably on the wiper shaft above and below the pinion. To axially secure and to axially guide the gear, the gear housing and the housing cover have a respectively opposite run-on surface. As a result, the wiper shaft is simultaneously guided and secured axially via the run-on surface on the gear housing and via the run-on surface on the gear cover.

Laid-open specification DE 42 19 480 A1 discloses a further window wiper drive for a motor vehicle, the drive having a correspondingly designed gear arrangement in order to produce different wiping angles. According to an exemplary embodiment, the gear arrangement is realized in the manner of a crank mechanism. One end of the toggle-lever-like crank drive is driven by a worm wheel. The other end is connected in a rotationally fixed manner to a wiper shaft. The driven wheel can have at least two optionally usable coupling points for the crank drive or can have at least one coupling point which can be adjusted in relation to the axis of rotation in the radial direction of the wheel. A combination of both of them may also be provided. The object is therefore pursued of providing a window wiper drive for a motor vehicle, which can be used in different drives in order to realize different wiping angles while maintaining a predetermined parking position of the wiper.

However, in the case of the known embodiments of various window wiper drives, there is frequently the problem that the window wiper drive has to be adapted to the particular embodiment of the gear arrangement. Although, in the case of optional use of the coupling points for the crank drive or at least one coupling point which can be adjusted in relation to the axis of rotation in the radial direction of the wheel, flexible adaptation of the window wiper drive to various wiping angles and parking positions of the wipers is made possible, this structural configuration involves a considerable structural outlay.

Although, in contrast to the crank mechanism, the conversion mechanism achieves a greater angle over which the wipers can pass, the conversion mechanism is more complicated and therefore more expensive because of the toothing between the pinion and the toothed segment.

Depending on the model of vehicle, a smaller wiping angle, over which the wipers can pass, of a window wiper drive with a crank mechanism may also be sufficient. For this purpose, it is desirable to be able to select the window wiper drive in a manner specific to the vehicle. However, in the prior art, for this purpose the entire window wiper drive and in particular the geometrical configuration and the mechanical connecting points on the tailgate or the vehicle body have to be adapted for the particular use to the configuration of the wiper system and correspondingly configured structurally.

### SUMMARY OF THE INVENTION

It is therefore the object of the present invention to provide a window wiper drive which can be used more flexibly and can be installed independently of the type of gear into the tailgate or the body of a motor vehicle with little structural outlay.

The invention provides a window wiper system with a window wiper drive, with a gear housing, which can be closed by means of a housing cover, for accommodating a gear arrangement, wherein the gear housing and the housing cover each have a run-on surface for the axial guidance of the gear arrangement, characterized in that, in order to accommodate different gear arrangements, when the housing cover is closed an intermediate space is formed between the mutually opposite run-on surfaces, said intermediate space corresponding to the geometrical dimensions of an installation region provided on the gear arrangement, the installation region of the different gear arrangements being of uniform design.

The invention includes the technical teaching that, in order to accommodate different gear arrangements, when the housing cover is closed an intermediate space is formed between the mutually opposite run-on surfaces, said intermediate space corresponding to the geometrical dimensions of an installation region provided on the gear arrangement, the installation region of the different gear arrangements being of uniform design.

This solution affords the advantage that, with an identical design of the insertion region of the conversion mechanism and of the crank mechanism, an optional installation or exchange of different embodiments of the gear arrangement within a standard gear housing is also possible, and it can therefore be decided only later in the subsequent stage of the project, for example depending on the type of vehicle, which design of gear is actually to be installed in the window wiper drive.

The intermediate space corresponds to the distance between the run-on surface of the gear housing and the run-on surface on the housing cover. When the gear arrangement is inserted into the gear housing, the latter is then closed by means of the housing cover. With the housing cover closed, the two run-on surfaces are opposite each other, and the gear arrangement is guided axially, i.e. in the direction of the wiper shaft axis of the wiper shaft. As a result, the gear arrangement is guided between the gear housing and the housing cover and the wiper shaft is fixed axially with respect to the gear housing.

This geometrical configuration enables the gear arrangement to comprise, for example, a conversion mechanism or a crank mechanism.

According to an embodiment of the invention, a conversion mechanism is inserted into the housing. The conversion mechanism has a pinion placed onto the wiper shaft, and an upper and lower guide web respectively adjacent to the pinion, with the insertion region of the conversion mechanism being formed by the height of the pinion and of the guide webs. The upper and lower guide web is in each case arranged rotatably on the wiper shaft, with the pinion being pressed onto the wiper shaft in an axially and rotationally fixed manner. The torque which is transmitted to the wiper shaft is introduced via the pinion. As an alternative, just one individual guide web can also be provided. The installation region formed by the individual guide web and the pinion corresponds, however, in the same manner to the intermediate space of the mutually opposite run-on surfaces between the gear housing and the housing cover.

According to an alternative embodiment of the invention, a crank mechanism is inserted by means of its insertion region into the housing. In this exemplary embodiment, the crank mechanism has a lever element pressed onto the wiper shaft, with the insertion region being formed by the height of the lever element. The lever element is pressed onto the wiper shaft and transmits the torque to the wiper shaft. The omission of a toothing in this embodiment enables the torque to be transmitted directly to the wiper shaft via the lever element, with the lever element being coupled by means of a connecting rod. In this case, the lever element has, at least in the region of the wiper shaft, the height corresponding to the installation region, with it being possible for the lever element to be of single- or multi-part design such that, for example, the lever element can be reinforced by means of a correspondingly designed attachment in the region in which it is pressed over the wiper shaft. By means of this embodiment, the lever element can have a greater thickness in the region of the wiper shaft than in the region of the articulated connection to the connecting rod.

According to a further advantageous embodiment of the invention, the wiper shaft is mounted in a guide bore made in the gear housing. The run-on surface formed on the gear housing is formed by the end surface of the guide bore, which opens into the gear housing, such that the wiper shaft extends through the run-on surface. By means of this arrangement, those components of the gear arrangement which are placed or pressed onto the wiper shaft can be brought to bear flat against the run-on surface in the gear housing. The run-on surface is therefore present in the gear housing in the form of an annular surface such that the at least one guide web is brought to bear flat against the run-on surface of the gear housing.

The run-on surface formed on the housing cover can be formed by the end surface of an annular elevation, which is formed radially around the wiper shaft axis, in the inside of the housing cover. The annular elevation in the inside of the housing cover can have the same inside diameter and the same outside diameter as the run-on surface in the gear housing.

When the conversion mechanism is installed, the annular elevation comes to bear flat against the outer guide web which is mounted on the end side of the wiper shaft. By contrast, when the crank mechanism is installed, only the lever element comes to bear flat against the annular elevation within the housing cover. Since the annular elevation in the inside of the housing cover is likewise formed radially around the wiper shaft axis, the two annular run-on surfaces are plane-parallel opposite each other.

According to a further exemplary embodiment, it is provided that the space which is enclosed by the inside of the gear housing and the housing cover and is intended for the gear arrangement is provided geometrically in such a manner that the operation of the gear arrangement both when designed as a conversion mechanism and as a lever mechanism can be implemented in a collision-free manner. In this case, in particular the region of the connecting rod and of the lever element or of the pinion and of the guide webs of the interior of the gear housing and of the housing cover should be designed in such a manner that the respective gear arrangement can move in a collision-free manner within the gear housing or the housing cover. It should also be taken into consideration that the window wiper drive is nevertheless of compact construction in order to keep the construction space as small as possible. The outer contour of the gear housing and of the housing cover should therefore be as close as possible to the enveloping shape formed both by the conversion mechanism and by the crank mechanism.

In one exemplary embodiment, the conversion mechanism and the lever mechanism can have a worm wheel, with the worm wheel of the conversion mechanism and of the lever mechanism having a mutually identical design. Furthermore, it is provided that the window wiper drive comprises a drive motor with a worm, with the drive motor and the worm for driving the conversion mechanism or the lever mechanism having a mutually identical design. Therefore, the installation, which has to be undertaken according to choice, of the gear arrangement can be limited to the components of the connecting rod, of the pinion, of the lever element and of the guide webs if the drive motor and the worm wheel and also the worm are designed as identical parts. The differing components between the conversion mechanism and the crank mechanism are therefore limited to the connecting rod, the pinion and the two guide webs for the conversion mechanism and to the connecting rod and the lever element for the crank mechanism.

Depending on the radius on which the connecting rod is attached to the worm wheel by means of a hinge pin, the connecting point of the connecting rod, which is designed with a toothed segment for the embodiment of the conversion mechanism, can be exchanged in a simple manner for a connecting rod which does not have a toothed segment if a crank mechanism is to be installed. Furthermore, by removal of the housing cover, the wiper shaft can be removed out of the gear housing in the direction of the wiper shaft axis, with it being possible for the interference fit of the wiper shaft with the lever element if a crank mechanism is to be installed, or for the interference fit of the wiper shaft with the pinion and the assembly of the two guide webs to be exchanged.

According to a further exemplary embodiment of the invention, it is provided that the gear housing is produced from an aluminum diecasting and/or the housing cover is produced from a plastics material. Furthermore, it can be provided that the gear housing itself is also produced from a plastics material by injection molding. Depending on the fit which is provided for the installation region, the plastic housing cover, which is preferably composed of a flexible material, can be designed in such a manner that, in the installed state of the gear arrangement and with the housing cover screwed onto the gear housing, a prestress is applied to the gear arrangement between the run-on surfaces in order to prestress the gear arrangement within the housing in a manner free from play.

Further measures improving the invention are illustrated in more detail below with reference to figures and together with the description of a preferred exemplary embodiment of the invention.

### BRIEF DESCRIPTION OF THE DRAWINGS

In the figures:

FIG. 1 shows a plan view of a window wiper drive with a conversion mechanism installed therein;

FIG. 2 shows a lateral cross-sectional view of the window wiper drive with an installed conversion mechanism;

FIG. 3 shows an illustration of a pinion, of at least one guide web and of a connecting rod with a toothed segment of a conversion mechanism;

FIG. 4 shows a cross section through a side view of the conversion mechanism from FIG. 3;

FIG. 5 shows a top view of a window wiper drive with a crank mechanism installed therein;

FIG. 6 shows a cross section through a side view of the window wiper drive with a crank mechanism;

FIG. 7 shows an illustration of a lever element, of a wiper shaft axis and a connecting rod of a crank mechanism;

FIG. 8 shows a cross section through a side view of the crank mechanism from FIG. 7.

### DETAILED DESCRIPTION

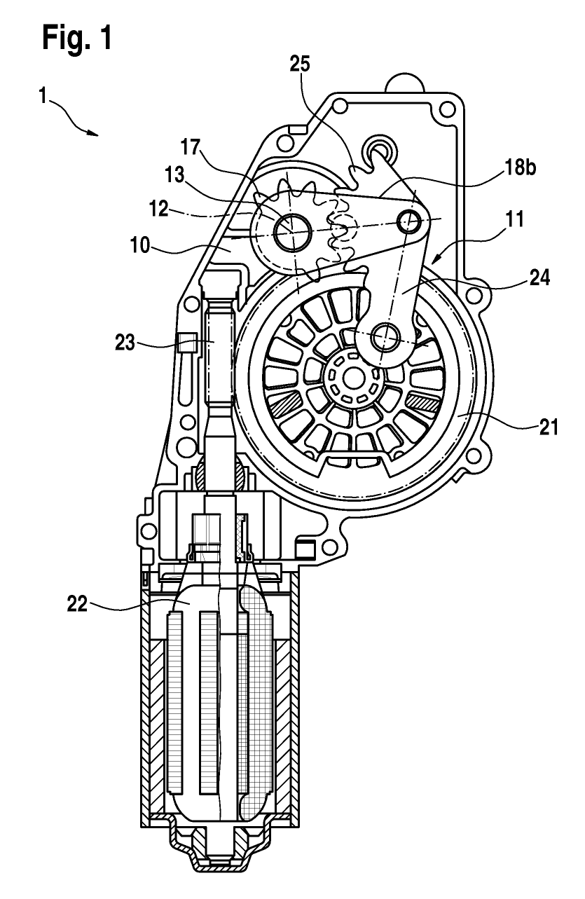

The window wiper drive 1 illustrated in FIG. 1 comprises a gear housing 10 in which a gear arrangement 11 is accommodated. The gear arrangement 11 serves to drive a wiper shaft 13 which executes an oscillating movement about a wiper shaft axis 12. In this case, the gear arrangement 11 is designed as a conversion mechanism which comprises a connecting rod 24 which is arranged in an articulated manner between at least one guide web 18 and a worm wheel 21. The worm wheel 21 is driven by means of a drive motor 22 via a worm 23, with the worm 23 meshing in the end toothing of the worm wheel 21. The worm wheel 21 therefore executes a continuous rotational movement. An articulated connection between the connecting rod 24 and the worm wheel 21, which articulated connection is eccentric with respect to the axis of rotation of the worm wheel 21, causes a lifting and oscillating movement in the connecting rod 24, with the connecting rod 24 being connected in an articulated manner to the guide web 18. Only one of two guide webs 18b is illustrated because of the top view of the gear arrangement 11, the guide web 18b being arranged above the connecting rod 24.

A second guide web is arranged non-visibly below the connecting rod 24. The connecting rod 24 comprises a toothed segment 25 which is in engagement with a pinion 17. By means of the lifting and oscillating movement of the connecting rod 24, the pinion 17 is set into an oscillating rotation. The pinion 17 is pressed in a rotationally fixed manner on the wiper shaft 13 such that the oscillating movement is transmitted to the wiper shaft 13. The guide web 18b is connected rotatably both to the connecting rod 24 and to the wiper shaft 13 such that the guide web 18b serves merely for the equidistant arrangement of the connecting rod 24 from the wiper shaft axis 12, and the toothing between the pinion 17 and the toothed segment 25 is maintained. By means of the arrangement of the conversion mechanism, an oscillating rotational movement of the wiper shaft 13 through, for example, 180° can be produced. In this case, the drive motor 22 executes a continuous rotational movement in a defined direction of rotation. The window wiper drive 1 furthermore comprises a housing cover 14 which has been removed in the present figure in order to illustrate the gear arrangement 11. The housing cover 14 therefore encapsulates the illustrated gear arrangement 11 within the gear housing 10.

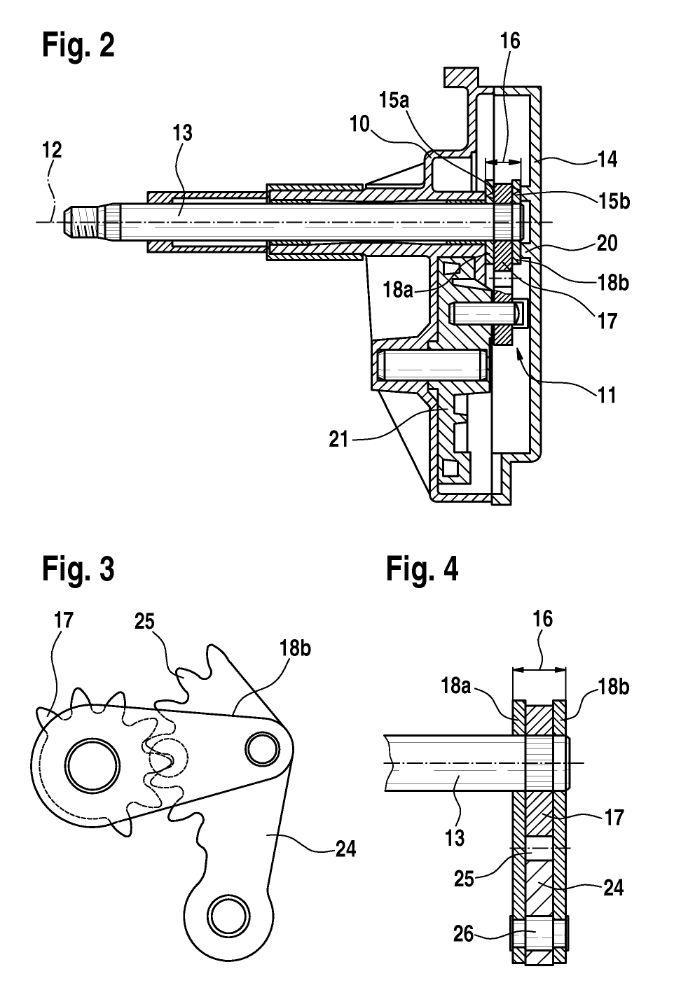

FIG. 2 shows a lateral cross-sectional view of a window wiper drive. The region of the drive motor is not illustrated in this view. The sectional plane of the illustration in FIG. 2 runs through the wiper shaft axis 12 and through the axis of rotation of the worm wheel 21. A run-on surface 15a is formed in the gear housing 10, with a run-on surface 15b being provided in the housing cover 14 opposite the run-on surface 15a. The two run-on surfaces 15a and 15b are therefore opposite each other. Between the two run-on surfaces 15a and 15b, the gear arrangement 11 is guided axially in the direction of the wiper shaft axis 12, with the gear arrangement 11 being designed as a conversion mechanism. Those components of the conversion mechanism which are guided between the run-on surfaces 15a and 15b comprise a guide web 18a adjacent to the gear housing 10 and a guide web 18b adjacent to the run-on surface 15b of the housing cover 14 and the pinion 17 arranged between the guide webs 18a and 18b. The height of the gear arrangement 11 between the run-on surfaces 15a and 15b corresponds to an installation region 16 which at the same time comprises the distance between the two run-on surfaces 15a and 15b.

The pinion 17 is pressed over a knurled region on the wiper shaft 13 such that the torque for driving the oscillating movement of the wiper shaft 13 can be transmitted. The housing cover 14 encapsulates the gear housing 10 over the entire region of the gear arrangement 11, and furthermore takes on the function of the axial guide by means of the annular elevation 20, on the end side of which the run-on surface 15b is formed. The annular elevation 20 is formed radially symmetrically about the wiper shaft axis 12 such that the two run-on surfaces 15a and 15b each run concentrically around the wiper shaft axis 12.

FIG. 3 shows an arrangement of a conversion mechanism with a pinion 17 and a connecting rod 24 which are arranged at a uniform spacing from each other by means of a guide web 18b. The connecting rod 24 has a toothed segment 25 which meshes in the toothing of the pinion 17. The toothed segment 25 extends through an angular region which corresponds at least to the oscillating angle or the pivoting angle of the connecting rod 24 such that an oscillating angle of up to 180° can be obtained in the pinion 17. A bore is provided in the lower region of the connecting rod 24, by means of which bore the connecting rod 24 is connected to the worm wheel via a bolt connection.

FIG. 4 shows a cross section of a side view of the arrangement of the conversion mechanism according to FIG. 3. The pinion 17 therein is again illustrated in toothed engagement with the toothed segment 25 of the connecting rod 24. The pinion 17 is connected in an axially and rotationally fixed manner to the wiper shaft 13 via an interference fit, the interference fit comprising a knurled portion. The guide webs 18a and 18b are each arranged on the left and right sides adjacent to the pinion 17 and are accommodated rotatably on the wiper shaft 13. Furthermore, the guide webs 18a and 18b are each arranged laterally adjacent to the connecting rod 24 and are guided rotatably via a connecting bolt 26. The pinion 17 and the guide webs 18a and 18b together form an installation region 16 which extends from the first run-on surface 15a on the gear housing 10 as far as the second run-on surface 15b in the housing cover 14.

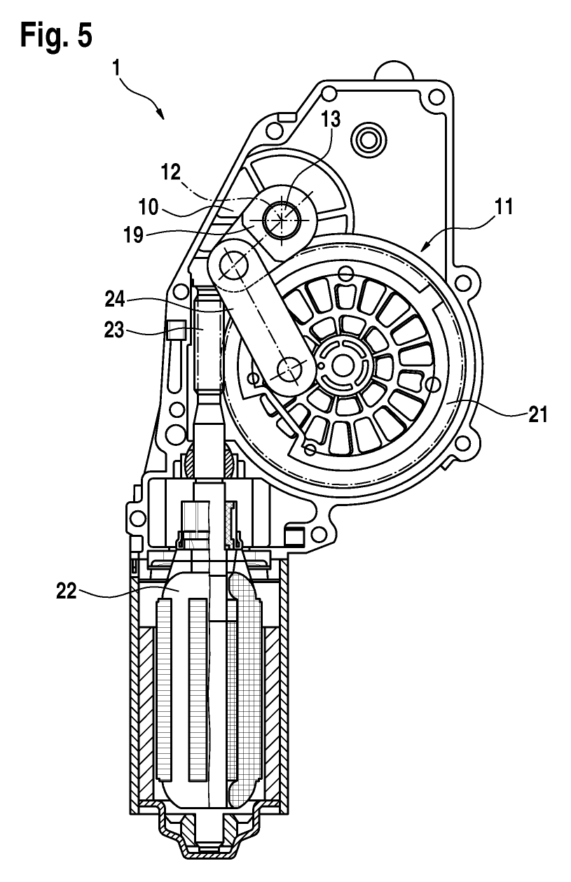

FIG. 5 shows a window wiper drive 1 in a top view, with the gear arrangement 11 illustrated being designed as a crank mechanism. The gear arrangement 11 essentially comprises a lever element 19 which is arranged in a rotationally fixed manner on a wiper shaft 13 in order to introduce an oscillating movement which can be executed about a wiper shaft axis 12 into the wiper shaft 13. The lever element 19 is connected in an articulated manner to a connecting rod 24 which introduces the torque into the lever element 19. The oscillating and lifting movement of the connecting rod 24 is brought about by an articulated connection to a worm wheel 21, with the articulated connection between the worm wheel 21 and the lever element 19 revolving eccentrically about the axis of rotation of the worm wheel 21. The worm wheel 21 is driven by a drive motor 22, the drive motor 22 executing a continuous rotational movement in a fixed direction of rotation and driving the worm wheel 21 via a worm 23.

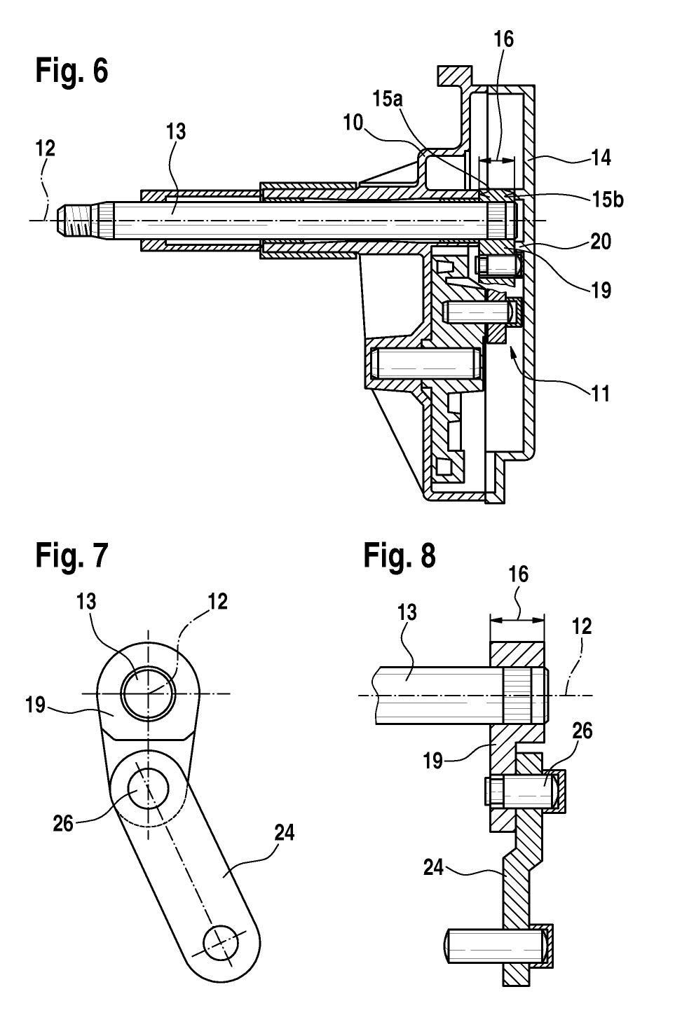

FIG. 6 illustrates the window wiper drive 1 according to the embodiment in FIG. 5 with a crank mechanism in a transversely sectioned side view. A gear arrangement 11 is inserted into the gear housing 10 and closed by means of a housing cover 14. The wiper shaft 13 which rotates about the wiper shaft axis 12 extends on the left side out of the gear housing 10, with the wiper shaft 13 projecting on the right side into the interior of the gear housing 10. The lever element 19 is pressed in a rotationally fixed manner onto the end of the wiper shaft 13. The lever element 19 has an installation region 16 which extends from the first run-on surface 15a on the gear housing 10 as far as the second run-on surface 15b in the housing cover 14. The run-on surface 15b in the housing cover 14 is formed by an annular elevation 20 which is arranged around the wiper shaft axis 12. By means of the respectively mutually adjacent arrangement of the run-on surface 15a of the gear housing, of the lever element 19 and of the run-on surface 15b in the housing cover 14, the gear arrangement 11 is guided axially, with, furthermore, the wiper shaft 13 being arranged in an axially fixed manner between the gear housing 10 and the housing cover 14.

FIG. 7 shows the components of the crank mechanism, which components comprise the lever element 19 and the connecting rod 24. Since the lever element 19 is pressed in a rotationally and axially fixed manner onto the wiper shaft 13, the torque for generating an oscillating movement about the wiper shaft axis 12 can be applied by the lever element 19. The lever element 19 is connected in an articulated manner to the connecting rod 24 which executes an oscillating and lifting movement which is produced by means of the articulated connection to the worm wheel.

FIG. 8 shows a cross section through a side view of the components of the crank mechanism from FIG. 7. An installation region 16 is formed in the region of the wiper shaft 13, with the height of the lever element 19 being reduced in the region of the connecting bolt 26 in order to minimize the overall height of the gear arrangement. The lever element 19 is connected in an articulated manner to the connecting rod 24 by means of the connecting bolt 26.

The invention is not restricted in its implementation to the preferred exemplary embodiment indicated above. On the contrary, a number of variants is conceivable with use also being made of the solution illustrated, even in versions of a fundamentally different type.

1. A window wiper system with a window wiper drive (1) with a gear housing (10), which can be closed by means of a housing cover (14), for accommodating a gear arrangement (11), wherein the gear housing (10) and the housing cover (14) each have a run-on surface (15a, 15b) for the axial guidance of the gear arrangement (11), characterized in that, in order to accommodate different gear arrangements (11), when the housing cover (14) is closed an intermediate space (16) is formed between the mutually opposite run-on surfaces (15a, 15b), said intermediate space corresponding to the geometrical dimensions of an installation region (16) provided on the gear arrangement (11), the installation region (16) of the different gear arrangements (11) being of uniform design.

2. The window wiper drive (1) as claimed in claim 1, characterized in that the gear arrangement (11) comprises a conversion mechanism or a crank mechanism.

3. The window wiper drive (1) as claimed in claim 2, characterized in that the conversion mechanism has a pinion (17) pressed onto the wiper shaft (13), and an upper and a lower guide web (18a, 18b) respectively adjacent to the pinion (17), with the installation region (16) being formed by the height of the pinion (17) and of the guide webs (18a, 18b).

4. The window wiper drive (1) as claimed in claim 2, characterized in that the crank mechanism has a lever element (19) pressed onto the wiper shaft (13), with the installation region (16) being formed by the height of the lever element (19).

5. The window wiper drive (1) as claimed in claim 1, characterized in that the wiper shaft (13) is mounted in a guide bore made in the gear housing (10), and the run-on surface (15a) formed on the gear housing (10) is formed by the end surface of the guide bore, which opens into the gear housing (10), such that the wiper shaft (13) extends through the run-on surface (15a).

6. The window wiper drive (1) as claimed in claim 1, characterized in that the run-on surface (15b) formed on the housing cover (14) is formed by the end surface of an annular elevation (20), which is formed radially around the wiper shaft axis (12), in the inside of the housing cover (14).

7. The window wiper drive (1) as claimed in claim 1, characterized in that the space which is enclosed by the inside of the gear housing (10) and the housing cover (14) and is intended for the gear arrangement (11) is provided geometrically in such a manner that the operation of the gear arrangement (11) both when designed as a conversion mechanism and as a lever mechanism can be implemented in a collision-free manner.

8. The window wiper drive (1) as claimed in claim 1, characterized in that the wiper shaft (13) is guided axially in the direction of the wiper shaft axis (12) by means of the run-on surfaces (15).

9. The window wiper drive (1) as claimed in claim 1, characterized in that the conversion mechanism and the lever mechanism have a worm wheel (21), with the worm wheel (21) of the conversion mechanism and of the lever mechanism having a mutually identical design.

10. The window wiper drive (1) as claimed in claim 1, characterized in that the window wiper drive (1) comprises a drive motor (22) with a worm (23), with the drive motor (22) and the worm (23) for driving the conversion mechanism or the lever mechanism having a mutually identical design.

11. The window wiper drive (1) as claimed in claim 5, characterized in that the run-on surface (15b) formed on the housing cover (14) is formed by the end surface of an annular elevation (20), which is formed radially around the wiper shaft axis (12), in the inside of the housing cover (14).

12. The window wiper drive (1) as claimed in claim 11, characterized in that the space which is enclosed by the inside of the gear housing (10) and the housing cover (14) and is intended for the gear arrangement (11) is provided geometrically in such a manner that the operation of the gear arrangement (11) both when designed as a conversion mechanism and as a lever mechanism can be implemented in a collision-free manner.

13. The window wiper drive (1) as claimed in claim 12, characterized in that the wiper shaft (13) is guided axially in the direction of the wiper shaft axis (12) by means of the run-on surfaces (15).

14. The window wiper drive (1) as claimed in claim 13, characterized in that the conversion mechanism and the lever mechanism have a worm wheel (21), with the worm wheel (21) of the conversion mechanism and of the lever mechanism having a mutually identical design.

15. The window wiper drive (1) as claimed in claim 14, characterized in that the window wiper drive (1) comprises a drive motor (22) with a worm (23), with the drive motor (22) and the worm (23) for driving the conversion mechanism or the lever mechanism having a mutually identical design.
